(19) United States
(12) Patent Application Publication
(10) Pub. No.: US 2022/0241773 A1
(43) Pub. Date: Aug. 4, 2022

(54) ASSAY PLATE WITH NANO-VESSELS AND SAMPLE RECOVERY ASSEMBLY

(71) Applicant: SCIENION GMBH, Berlin (DE)

(72) Inventor: Joshua CANTLON-BRUCE, Spokane, WA (US)

(21) Appl. No.: 17/607,723

(22) PCT Filed: May 8, 2020
(86) PCT No.: PCT/EP2020/062868

§ 371 Date: Oct. 29, 2021

Related U.S. Application Data
(60) Provisional application No. 62/844,965, filed on May 8, 2019.

(51) Int. Cl. B01L 3/00

(52) U.S. Cl. CPC B01L 3/5025; B01L 2400/0409; B01L 2200/026; B01L 2400/0457; B01L 2300/0609; B01L 2300/0829; B01L 2400/084; B01L 2200/16

(57) ABSTRACT

An assay plate is provided. The assay plate has a body with a plurality of reservoirs formed therein. The reservoirs are shaped and aligned in the body in an orientation to induce drainage of fluids contained therein in a desired direction. A plate array and a funnel array forming an assembly for pooling of samples contained in the assay plate is also provided.

### CROSS REFERENCE TO RELATED APPLICATIONS

This application claims priority to U.S. 62/844,965 filed May 8, 2019, entitled Assay Plate with Nano-Vessels and Sample Recovery Assembly, the contents of which are herein incorporated by reference in its entirety.

### FIELD OF THE INVENTION

The present invention is in the field of biochemical analysis and provides assay plates, plate arrays and assemblies including recovery funnels for recovery of samples from reservoirs on the assay plates.

### BACKGROUND

Single-cell studies have become more prominent in recent years in fields such as stem cell biology, hematology, cancer biology and tissue engineering. Measuring cells in populations involves analysis of average signals from a large number of cells. It is highly challenging to analyze cell types constituting a minority in such samples because their properties are hidden by the majority population. Thus, an appropriate analysis of samples with significant cellular heterogeneity is ideally performed on a single-cell level. Many applications in drug discovery or medical diagnostics, such as single-cell microarrays, single-cell PCR, isolation of rare cells, or production of clonal cell lines, could benefit significantly from analytical approaches based on single cells.

In practice, separation and manipulation of individual living biological cells remains a challenging task in many life science applications. At present, the commercially available technologies to separate single cells from a suspension and deposit them individually on substrates are quite rare, especially regarding processing of nontreated samples and label-free cells (Gross et al. J. Lab. Automation 2013, 18(6), 504-518, incorporated herein by reference in its entirety).

Technologies for single-cell isolation, e. g. for handling of single cells in biotechnology and medicine, include flow cytometry, manual cell picking, microfluidic techniques, and inkjet-like single-cell printing. In general terms, a single-cell printer isolates a single cell and places it in a receptacle having a micro- or nano-scale volume wherein a subsequent assay is conducted. A single-cell printer typically comprises a microfluidic dispenser integrated in a polymer cartridge. Droplets of a cell suspension included in the dispenser are deposited in a receptacle on a target substrate. Single-cell printing has advantages in terms of flexibility and easy interfacing with other upstream and downstream methods. However, single-cell printers have to be controlled such that each droplet deposited onto the target includes one single cell only (Gross et al. Int. J. Mol Sci. 2015, 16, 16897-16919, incorporated herein by reference in its entirety).

Examples of single cell printing are described and claimed in commonly owned European Patent Application Publication No. EP3222353 and European Patent Application No. EP17189875, each of which are incorporated herein by reference in entirety.

There continues to be a need for development of technologies for single cell isolation and manipulation.

### SUMMARY

One aspect of the invention is an assay plate which includes a body having a plurality of reservoirs formed therein. The reservoirs are shaped and aligned in the body in an orientation to induce drainage of fluids contained therein in a desired direction. The desired direction may be towards a single plane or a single point.

In some embodiments, the reservoirs each have a spout portion which has a vertex directed toward the single plane or the single point.

The reservoirs may be provided with a downwardly tapered frustoconical portion adjacent to the spout portion. The frustoconical portion may have a frustrum forming the base of the reservoir.

The reservoirs may have a boundary between the frustoconical portion and the spout portion defined by a pair of opposed transition planes each intersecting an inner sidewall of the reservoir at distances equidistant from the vertex such that a connectivity plane located between the vertex and the center of the base divides the spout into symmetric halves. In such embodiments, a first angle between a first perpendicular reference plane intersecting the edge of the base closest to the vertex and the connectivity plane is greater than a second angle between a second perpendicular reference plane intersecting the edge of the base in the frustoconical portion and an interior sidewall of the frustoconical portion.

The reservoir may have a teardrop-shaped upper edge and the base may be circular or teardrop shaped.

In some embodiments, the spout includes a ledge portion, wherein a third angle between the first perpendicular reference plane and the connectivity plane on the ledge portion is greater than the first angle between the first perpendicular reference plane intersecting the edge of the base closest to the vertex and the connectivity plane.

In some embodiments, the body of the plate array may be rectangular and provided with a downward slope from a single elevated corner, wherein the desired direction of the drainage of fluids is towards the corner opposite the elevated corner. In other embodiments, the body may be rectangular with a level upper surface.

In some embodiments, the plurality of reservoirs is 96 reservoirs.

In some embodiments, the reservoirs have volumes of less than about 200 nanoliters.

Another aspect of the invention is a plate array comprising a plurality of assay plates of the embodiments described hereinabove. In one embodiment, the plurality of assay plates is four plates.

Another aspect of the invention is assembly for pooling assay samples contained in reservoirs of plate arrays. The assembly may include a rectangular plate array as described hereinabove and a rectangular funnel array comprising a plurality of rectangular funnels, each configured for connection to a single plate of the plurality of plates.

Each of the rectangular funnels of the funnel array may have a collecting vessel located closer to one funnel corner such that when the funnel array is connected to the plate array, the desired direction of drainage of fluids from each plate of the plurality of rectangular plates is towards the collecting vessel of the connected funnel.

The corners of the plate array may be shaped to accept the corners of the funnel array in only a single orientation, thereby ensuring that the desired direction of drainage of fluids is towards the collecting vessel.

A transverse channel may be provided between adjacent plates of the plate array.

The assembly may also include a housing for coupling the assembly to a rotor of a centrifuge.

Another aspect of the invention is a kit for conducting an assay. The kit includes a plate array as described hereinabove, a rectangular funnel array comprising a plurality of rectangular funnels, each configured for connection to a single plate of the plurality of plates, and instructions for connecting the funnel array to the plate array for draining fluids from the reservoirs of the plate array via centrifugation.

The kit may also include a housing for retaining the plate array and funnel array in a connected arrangement in a centrifuge.

In some embodiments of the kit, the collecting vessels are attached to or formed integrally with the funnels of the funnel array.

The kit may also include a frame configured to hold the plate array during dispensing of components into the reservoirs during preparation of the assay.

In some embodiments of the kit, each one of the reservoirs includes an identifier for identifying each one of the reservoirs during the assay. The identifier may be a nucleic acid molecule, protein, glycan, peptide, aptamer, small molecule, nanoparticle, or a heavy metal with an isotope which is identifiable by mass spectrometry. Other analytical techniques may be used to confirm the presence of the identifier.

The kit may also include reagents for the assay provided in individual vessels.

In some embodiments of the kit, the assay is a sequencing assay, a gene expression assay or a protein expression assay.

The details of various embodiments of the disclosure are set forth in the description below. Other features, objects, and advantages of the disclosure will be apparent from the description, drawings, and the claims. In the description, the singular forms also include the plural unless the context clearly dictates otherwise. Unless defined otherwise, all technical and scientific terms used herein have the same meaning as commonly understood by one of ordinary skill in the art to which this disclosure belongs. In the case of conflict, the present description will control.

### BRIEF DESCRIPTION OF THE DRAWINGS

The foregoing and other objects, features and advantages will be apparent from the following description of particular embodiments of the disclosure, as illustrated in the accompanying drawings. The drawings are not necessarily to scale, emphasis instead being placed upon illustrating the principles of various embodiments of the disclosure.

FIG. 1A is a partial perspective view of a first embodiment of a plate array 100.

FIG. 1B is a magnified view of inset 1B of FIG. 1A.

FIG. 1C is a magnified view of inset 1C of FIG. 1A.

FIG. 1D is a magnified view of inset 1D of FIG. 1A

FIG. 2A is a top perspective view of a second embodiment of a plate array 200.

FIG. 2B is a magnified view of inset 2B of FIG. 2A showing the shape of each individual reservoir 240 and a frame channel 232.

FIG. 2C is a top view of plate array embodiment 200.

FIG. 2D is a magnified view of inset 2D of FIG. 2C.

FIG. 2E is a partial side view of plate array 200 showing the shape of the reservoirs 240 with dashed lines.

FIG. 2F is a magnified view of inset 2E of FIG. 2F showing transition planes 247a,b, connectivity plane 245, spout 248 and spout vertex 246 with solid lines.

FIG. 3 is a top perspective view of a single reservoir 240.

FIG. 4A is a top view of reservoir 240 showing the same features of FIG. 3 and further with a rotation axis A plane P-1 and plane P-2.

FIG. 4B is a side elevation view of reservoir 240 representing a 90-degree rotation of axis A and indicating a first angle α between plane P-1 perpendicular to the interior base surface 243 of the reservoir 240 and the connectivity plane 245 central to the spout 248 and a second angle θ between plane P-2 perpendicular to the interior base surface 243 of the reservoir 240 and an interior sidewall 242 of the reservoir which does not form part of the spout 248.

FIG. 5 is a diagram in two steps (I and II) indicating geometric construction of the outer edge of reservoir 240.

FIG. 6A is a top view of another embodiment of a reservoir 340 which has a circular base 343 instead of the teardrop-shaped base 243 of reservoir 240.

FIG. 6B is a top perspective view of reservoir 340 of FIG. 6A.

FIG. 7 is a diagram in two steps indicating geometric construction of the outer edge of reservoir 340.

FIG. 8A is a top perspective view of a funnel array 360.

FIG. 8B is a side perspective view of the funnel array 360 of FIG. 8A.

FIG. 8C is a bottom perspective view of the funnel array 360 of FIGS. 8A and 8B.

FIG. 9 is a diagram indicating connection of a funnel array 360 to plate array 300 and collecting vessels 370a-d to the outlets 362a-d of funnels 361a-d of the funnel array 360.

FIG. 10A is a top perspective view of a funnel array 560.

FIG. 10B is a side perspective view of the funnel array 560 of FIG. 10A.

FIG. 10C is a bottom perspective view of the funnel array 560 of FIGS. 10A and 10B.

FIG. 11A shows the first three steps of a process for processing a single cell solution in reservoir 240.

FIG. 11B shows an additional three steps of a process for processing a single cell solution in reservoir 240.

FIG. 12A is a diagram indicating movement of a processed cell solution S-1 out of the reservoir 240 with centrifugation towards the interior surface of a funnel.

FIG. 12B is a diagram indicating movement of the processed cell solution S-1 along the interior surface of the funnel 266 after exit from the reservoir 240 for sample pooling.

FIG. 13A is a top view of plate array embodiment 400.

FIG. 13B is a magnified view of inset 13B of FIG. 13A.

FIG. 13C is a partial side view of plate array 400 showing the shape of the reservoirs 440 with dashed lines.

FIG. 13D is a magnified view of inset 13D of FIG. 13C showing transition planes 447a,b, connectivity plane 445, spout 448, spout ledge 451 and spout vertex 446 with solid lines.

FIG. 14 is a top perspective view of a single reservoir 440.

FIG. 15 is a diagram indicating dispensing of a reagent into a reservoir 440 which includes a spout ledge 451.

FIG. 16 is a diagram indicating how the reservoir embodiment 440 can be used to retain a reagent R-1 on the spout ledge 451, where it is reconstituted with a solvent and centrifuged to mix the reconstituted reagent R-1 with a second reagent at the bottom of the reservoir 440.

FIG. 17 is a diagram indicating dispensing of a single cell C in a reaction fluid R-3 onto the ledge 451 of the reservoir 440 followed by imaging while the single cell C remains on the ledge 451, prior to centrifugation to move the single cell C to the bottom of the reservoir 440.

FIG. 18A shows a schematic arrangement of a plane-focused arrangement of reservoirs where the vertex of the spout of each reservoir points in the same direction.

FIG. 18B shows a schematic arrangement of a point-focused arrangement of reservoirs where the vertex of the spout of each reservoir is directed to the same point.

### DETAILED DESCRIPTION

### I. Introduction

The present inventors, being engaged in development of nanoscale devices and instrumentation for processing biomolecules and printing single cells have made a number of technological advances in single cell printing devices, such as for example, the devices described and claimed in commonly owned European Patent Application Publication No. EP3222353 and European Patent Application No. EP17189875 (each incorporated herein by reference in entirety). Such advances are expected to lead to development of additional efficiencies in a number of nano-scale assays such as various different types next generation sequencing, gene expression analyses and proteomics analyses of single cells. In the process of customization of various assays, the inventors have recognized certain shortcomings in conventional sample plates designed for use with samples at the nano-scale level. At the nano-scale, capillary action is an important contributor in determining flow of fluids into and out of sample reservoirs. In particular, problems arise during sequential dispensing of various reagents into such nano-scale reservoirs, which may prevent the desired mixing. For example, the inventors have discovered that dispensing of picoliter volumes into conventional nano-scale reservoirs will occasionally and consistently result in ejection of fluids from such reservoirs. This is a problematic occurrence because it will result in cross-contamination between reservoirs of a plate. Development of the shaped reservoirs described herein has been found effective in addressing this problem.

In addition, the same issues arise when removing samples from such reservoirs in situations where sample pooling is desired. The inventors have discovered that providing plate reservoirs which are individually shaped and aligned with each other will improve the flow of fluids into and out of the individual reservoir. This provides significant advantages in processing of samples at the nanoscale level. The advantages provided by the embodiments described herein are expected to be applicable to essentially any assay requiring dispensation of single cells, biomolecules, fluids, particles, reagents and solutions at the micro-, nano-, and pico-scale level.

The details of embodiments of the invention are set forth in the accompanying description below. Although any materials and methods similar or equivalent to those described herein can be used in the practice or testing of the present invention, the preferred materials and methods are now described. Other features, objects and advantages of the invention will be apparent from the description. In the description, the singular forms also include the plural unless the context clearly dictates otherwise. Unless defined otherwise, all technical and scientific terms used herein have the same meaning as commonly understood by one of ordinary skill in the art to which this invention belongs. In the case of conflict, the present description will control. A number of alternative features will be introduced during the course of describing various embodiments. Such alternative features may be combined to produce specific combinations which may not be described explicitly herein. Nonetheless, such alternative embodiments are within the scope of the invention. In the description below, similar reference numerals are used as identifiers of similar features in most cases.

### II. Array Plate with Shaped Reservoirs

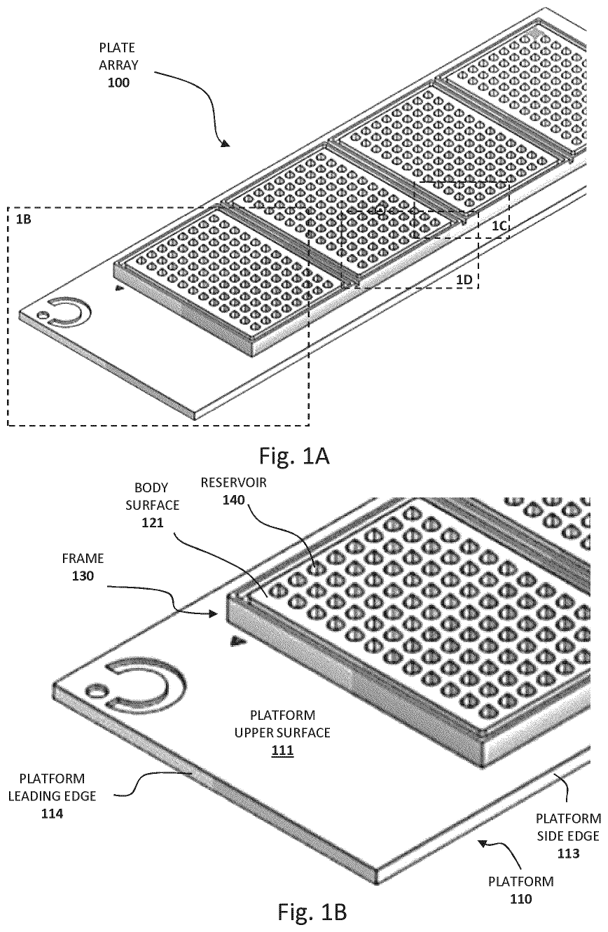

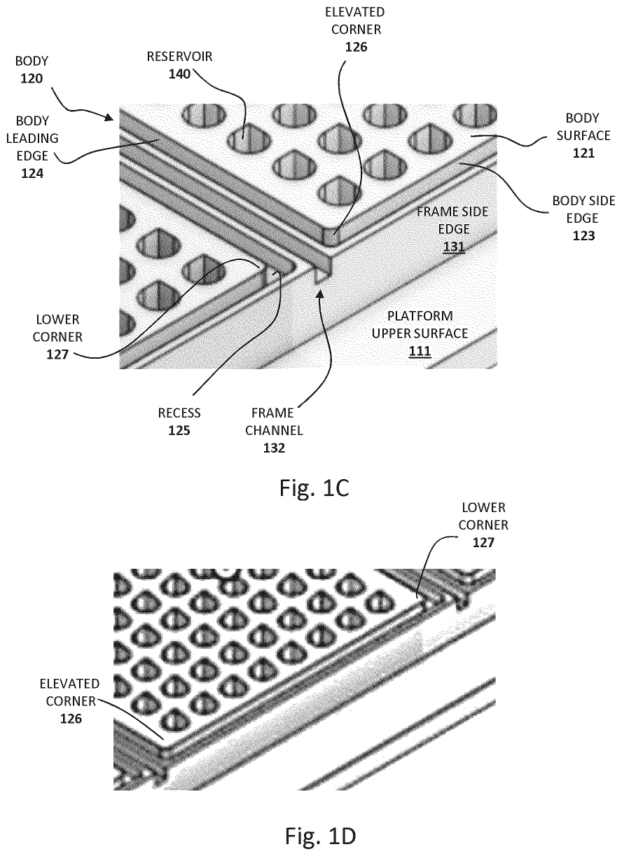

Turning now to FIGS. 1A to 1D, there is shown a first embodiment of a plate array 100, which includes four plates as shown, each having 96 reservoirs formed therein in a general configuration similar to a conventional 96-well microtiter plate (8×12 reservoirs). Alternative embodiments may have fewer or more reservoirs and/or fewer or more plates. The reservoirs 140 of this embodiment are nano-vessels, meaning that they are configured to hold nanoliter volumes. However, the features of this embodiment may also be used in plates configured to hold microliter volumes. The four plates of the present embodiment are each formed with a rectangular body 120 which is supported on or formed integrally with frame 130 on the upper surface 111 of a platform 110 having a leading edge 114, side edges 113 and a back edge which is not visible in the views shown). As noted, the upper body surface 121 of each plate has 96 reservoirs formed therein, each identified by reference numeral 140 as seen in FIGS. 1B and 1C. Thus, the plate array 100 with four plates includes a total of 384 reservoirs 140.

FIG. 1C is a magnified portion of FIG. 1A showing an edge area between two plates showing the edge 131 of the frame 130. The view shown in FIG. 1C indicates that the upper surface of the body 120 of each plate is sloped downward from an elevated corner 126 to lower corners 127 (in this view a lower corner of the left-middle plate (in the view shown) is opposite the elevated corner 126 of the adjacent plate to the right. FIG. 1D is a magnified view of one end of a single plate, indicating the elevated corner 126 and its front adjacent lower corner 127. Thus, each plate slopes downward from its elevated corner to provide one possible mechanism for improvement of draining of samples from the reservoirs 140, representing one feature of the invention. Other mechanisms will be described hereinbelow with respect to additional embodiments.

Additional features of the plate array 100 include frame channels 132 formed in the frame 130 between the plates and a recess 125 partly surrounding each plate. Thus, at the elevated corners 126 of each plate, the recess 125 is absent but as each plate slopes downward, it transitions to becoming partially circumscribed by the recess 125. As seen in FIG. 1C, the recess 125 is visible at areas adjacent to the lower corner 126 of the left middle plate, while the recess 125 is not seen circumscribing the adjacent plate in this view. Instead, the leading edge 124 of the body 120 and the side edge 123 of the body 120 is seen to be above the upper surface of the frame 130.

The recess 125 provides structure for connection of a recovery funnel (not shown) having a complementary recess-coupling ridge-like structure to facilitate drainage of the contents of the reservoir 140. An alternative embodiment described hereinbelow will be used to highlight the features of an array of recovery funnels.

It is to be noted that each of the reservoirs 140 is teardrop-shaped. All of these reservoirs are aligned with the teardrop vertex pointing away from the elevated corner 126 of each plate and towards the opposite corner. When the contents of the reservoirs are being removed by centrifugation, liquids are induced to drain into a recovery funnel in a direction opposite the elevated corner, exiting each reservoir at the vertex.

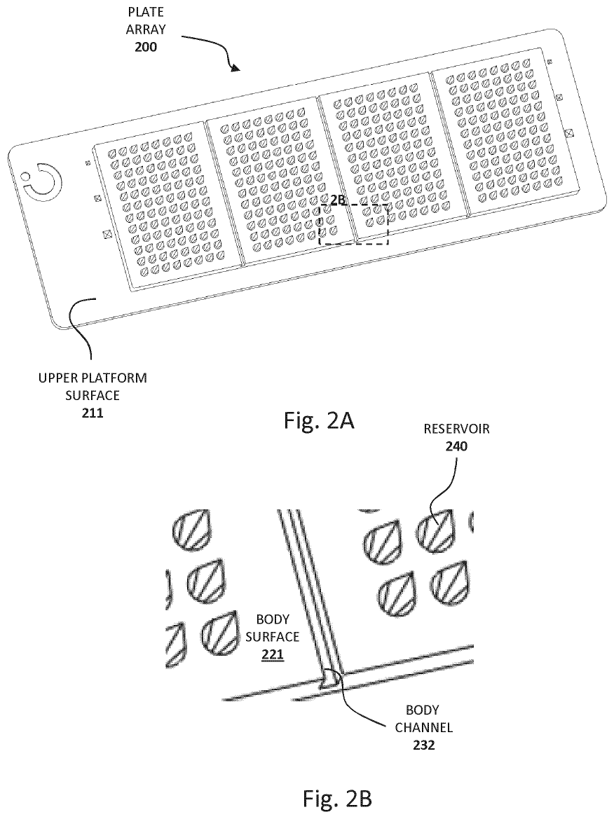

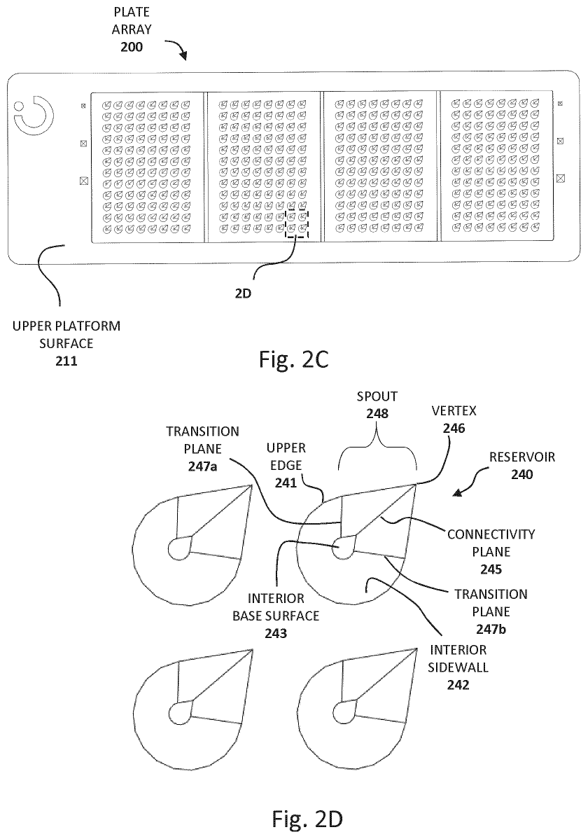

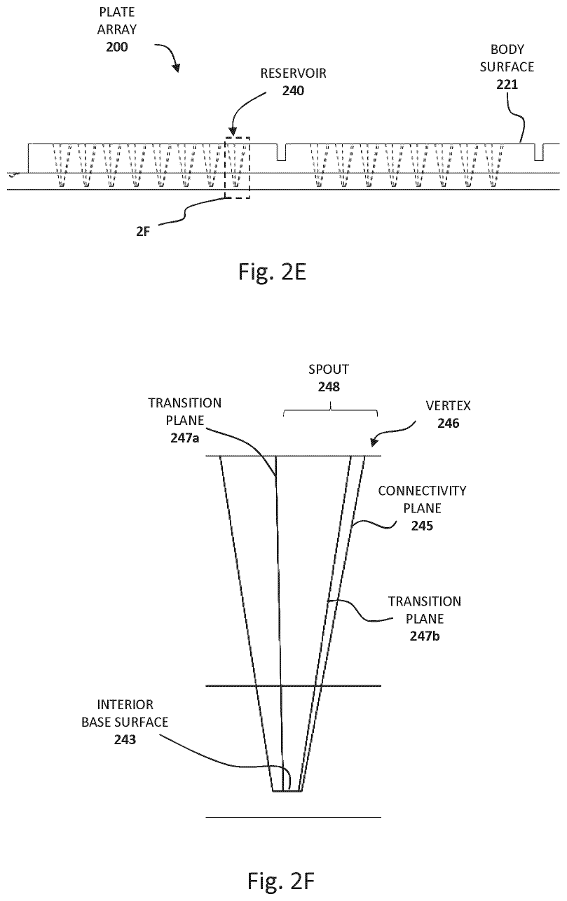

Turning now to FIGS. 2A to 4B, there is shown a second embodiment of a nano-vessel plate array 200 configured with four plates on an upper platform surface 211. This embodiment 200 differs from the plate array 100 described above, in having four plates which are not sloped. The upper surfaces of each plate are substantially horizontal with each of the four corners at substantially the same level. In addition, plate array 200 does not have a partially circumscribing recess as included in plate array 100.

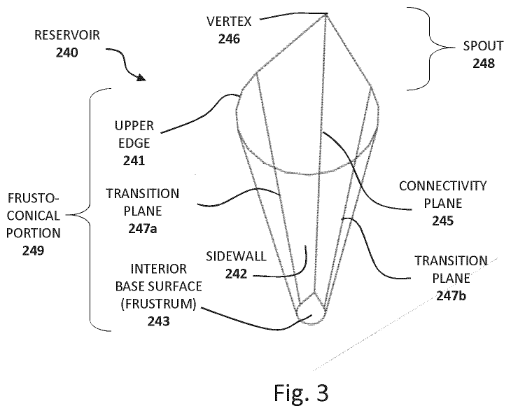

In plate array 200, the reservoirs 240 are also teardrop shaped. In the top views of four reservoirs 240 in FIG. 2D (representing a magnified inset of FIG. 2A) and particularly in the side views of FIGS. 2E and 2F, it is seen that each of the reservoirs 240 is tapered inwards towards its teardrop-shaped base surface 243. While the side elevation views of FIGS. 2E and 2F provide the general appearance of a cone-shaped reservoir 240, the perspective view of FIG. 3 more clearly indicates that each reservoir 240 is pitcher-shaped with a frustoconical portion 249 transitioning at planes 247a,b to form a spout portion 248 terminating at vertex 246 which is aligned with connectivity plane 245. Thus, most of the upper edge 241 of the reservoir 240 is circular with a transition to a straight line to the vertex 246 at each transition plane 247a,b.

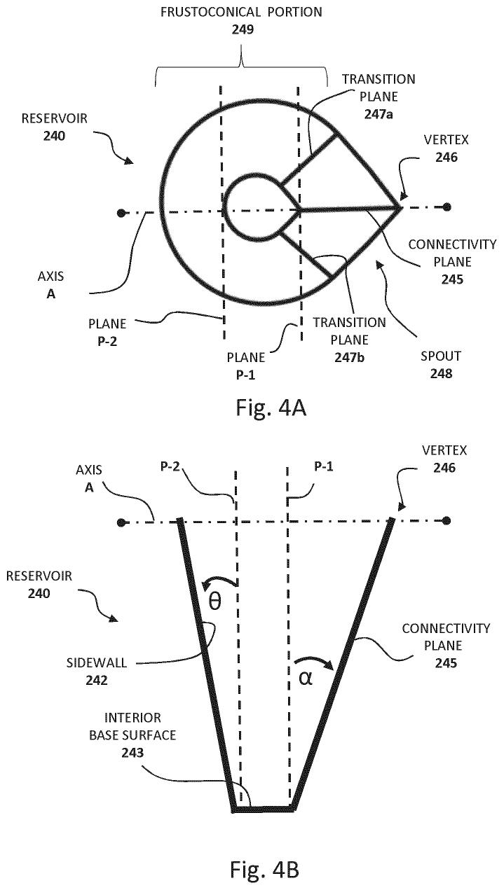

This pitcher-shaped reservoir 240 is defined by having a sidewall 242 with a slope transitioning from a steeper slope to more gradual slope at the spout portion 248 as shown in FIG. 4B, which represents a cross-sectional side view of the reservoir 240 as generated by a 90-degree rotation of the top view of reservoir 240 along axis A of FIG. 4A. FIG. 4B demonstrates that the angle α between a perpendicular reference plane P-1 intersecting the edge of the base 243 closest to the vertex 246 and the connectivity plane 245 is greater than the angle θ between a perpendicular reference plane P-2 intersecting the edge of the base 243 in the frustoconical portion 249 and the interior sidewall 242 of the frustoconical portion 249.

This pitcher-shaped reservoir 240 has been found to be an effective reservoir shape to provide improvements in processes for dispensing fluids into the reservoir 240 and removal of sample fluids contained therein.

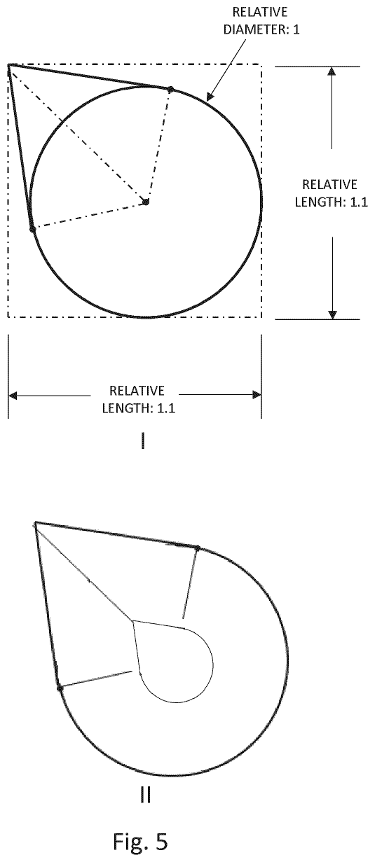

FIG. 5 is a diagram indicating one possible process for generating the geometric shape of the upper edge 241 of reservoir 240 and the shape of the reservoir 240 itself. This process is provided by way of example only. Other processes for generating this geometric shape and variant embodiments thereof may be used. First, a circle having a relative diameter of 1 is provided. The circle is placed within a square with sides having equal relative dimensions of 1.1 such that the circumference of the circle is offset from the center of the square and meets adjacent sides of the square. The corner of the square farthest from the circumference of the circle is defined as the vertex of the shape and a line is drawn from the center of the circle to the vertex (this line is aligned with the plane of connectivity 245). Next, a pair of points is identified along the circle such that a pair of equivalent triangles is defined by the center of the circle, the vertex and lines drawn between the pair of points and the vertex. The lines between the pair of points and the center of the circle represent the transition planes 247a,b and a line drawn between the center of the circle and the vertex represents the plane of connectivity 245 as noted above. Finally, in a third dimension, a base having the same shape but smaller dimension as the outer edge is placed centrally within the outer with aligned vertices at an appropriate distance below the outer edge, thereby defining sidewalls of the reservoir. The distance of the base from the outer edge of the reservoir and the size of the base will define the volume of the reservoir.

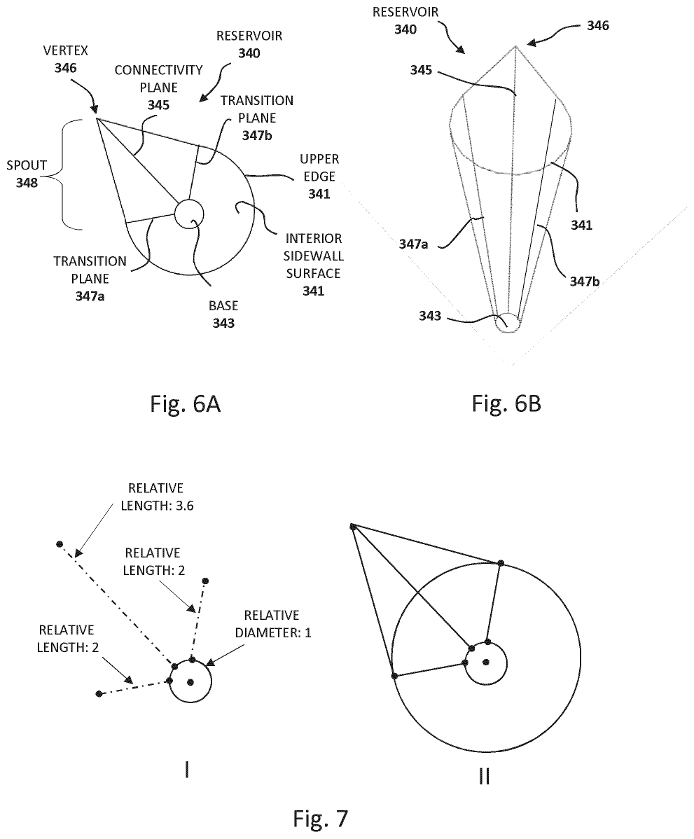

Turning now to FIGS. 6A and 6B, there are shown top and perspective views of an alternative reservoir embodiment 340 which is generally similar to reservoir embodiment 240 but differs in being provided with a circular base 343 instead of the teardrop-shaped base 243 of reservoir 240 in plate array 200. Otherwise, the teardrop-shaped upper edge 341, the transition planes 347a,b, the plane of connectivity 345, the vertex 346 and the spout 346 are generally arranged in a similar manner as described for reservoir embodiment 240. This reservoir embodiment 340 may be incorporated into a plate array such as plate array 100 or plate array 200 for example.

Functionally, this reservoir embodiment 340 differs from reservoir embodiment 240 in providing a more readily predictable flow pattern as a result of having a base with a uniformly circular base as well as being more reliably formed by 3D-printing or hot embossing. Alternative embodiments have bases with different shapes and dimensions. It is expected that a reservoir with a base having a reduced base surface area will provide certain advantages, such as functionality in concentration of fluids.

FIG. 7 shows one possible process for constructing the geometric shape of reservoir 340. Starting with a small circle of relative diameter of 1, a single line of relative length of 3.6 is lofted from this small circle to end at the vertex point. Then a pair of lines of relative length of 2 equidistant from the single line along the circumference of the circle are lofted outwards from the small circle. A large circle is centralized over the small circle such that the ends of the pair of lines meet the circumference of the large circle. At these meeting points, lines are drawn to meet the vertex to define the pointed end of the upper edge of the reservoir 340. With a third-dimension distance being defined between the small circle and the large circle, sidewalls of the reservoir 340 are defined, thereby defining the volume of the reservoir 340.

### III. Plate Array and Funnel Array Assembly for Pooling Samples

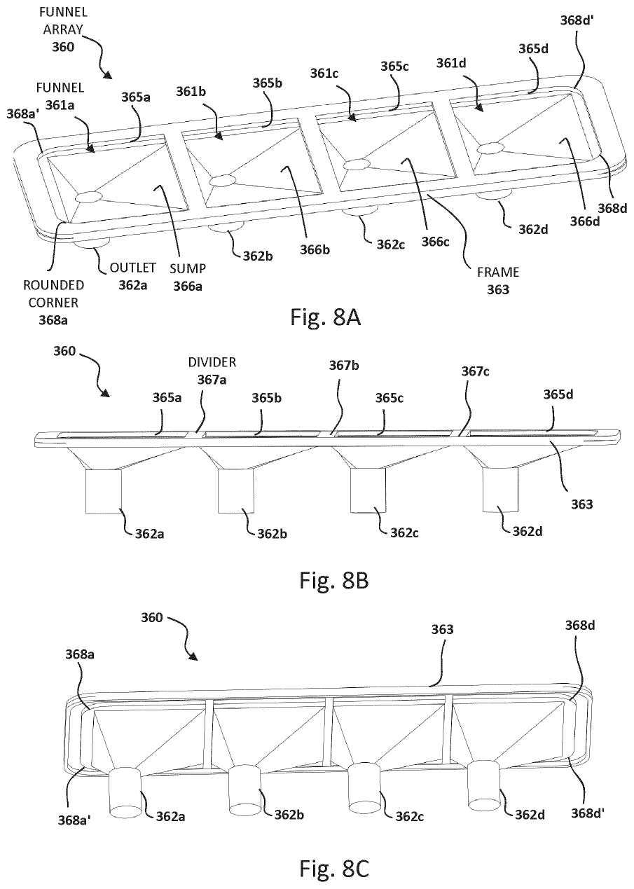

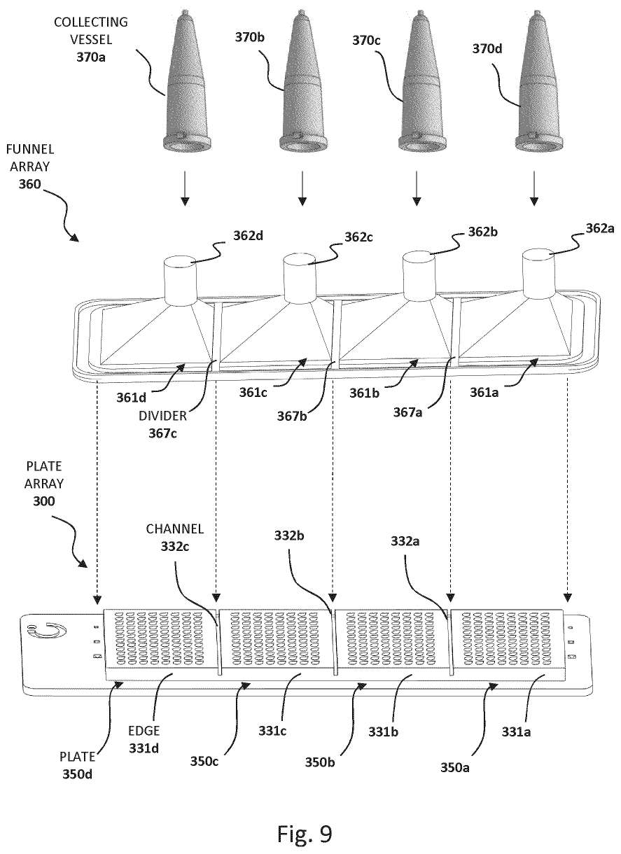

FIGS. 8A to 8C, FIGS. 9 and 10A to 10B illustrate features providing sample pooling functionality. FIGS. 8A to 8C show different perspective views of a funnel array 360 which is used to collect and pool samples contained in individual reservoirs 340 on the plates 350a-d of plate array 300, as shown in FIG. 9. Pooling of samples is done in assay situations where it is desirable to have a greater volume of a sample for subsequent analysis. For example, a first plate 350a of a plate array 300 may include the same type of cell in all of its operating reservoirs 340 where processing of the cell solution may be performed. Following processing of the solutions in the reservoirs 340, the contents of the reservoirs in this plate 350a can be pooled and collected using funnel 361a of the funnel array 360.

In FIGS. 8A to 8C, it seen that the funnel array 360 includes four generally rectangular funnels 361a-d which are formed in an array frame 363 such that each funnel 361a-d extends below the upper surface of the array frame 363. Each funnel 361a-d has a sump 366a-d formed of four sloped surfaces extending downwards from each side of the funnel 361a-d, leading to a drain outlet 362a-d.

The frame 363 of the funnel array 360 includes three transverse dividers 367a-c (best seen in FIG. 8B) which are integrally formed with the frame 363 and have upper surfaces which are coplanar with the upper surface of the frame 363. In an alternative embodiment, an additional function of the dividers 367a-c is to provide a coupling structure operating with a complementary coupling structure on the plate array 350. For example, the dividers could engage with appropriately dimensioned respective channels 332a-c between the plates.

It is seen in FIG. 8B that divider 367a forms a barrier between funnels 361a and 361b. If an assay was performed in the reservoirs 340 of two adjacent plates 350a and 350b with a first cell type in plate 350a and a second cell type in plate 350b, the pooled samples collected by funnels 361a and 361b would provide two distinct pooled samples each containing a specific cell type. In this embodiment, if sample fluid moving from a reservoir 340 to its respective funnel is incidentally induced to flow outwards via capillary action between the upper body surface 321 of the plate array 300 and the surface of the dividers 367a-c, of the funnel array 360, the capillary flow will be halted by the wider area at the channels 332a-c. This prevents cross-contamination between the funnels 361a-c.

In this embodiment, each funnel 361a-d has an upper portion with a relatively narrow vertical sidewall 365a-d which engages the side edges 332a-d of the plates 350a-d when the funnel array 360 is connected to the plate array 300. This provides an additional press-fit frictional engagement coupling mechanism to connect the funnel array 360 to the plate array 300.

The funnel array 360 has funnels 361a and 361d with rounded corners 368a, 368a′, 368d, and 368d′ to fit the corners of end plates 350a and 350d of the plate array 300. In this embodiment, the rounded corners are substantially similar. However, an alternative embodiment (not shown) of the funnel array 360 and plate array 300 assembly has a single uniquely-shaped corner at any one of the four locations in the funnel array 360 and in the plate array 300. This will ensure that connection of the funnel array 360 to the plate array 300 will be made in a proper orientation with the vertices and spouts of the reservoirs 340 of each plate 350a-d being directed towards the corner closest to the outlet of each connected funnel 361a-d of the funnel array 360. This alternative embodiment is particularly advantageous because the reservoirs 340 of the plate array 300 are small and it is challenging to identify the vertices and spouts of the reservoirs in order to ensure that they point towards the outlets 362a-d of the funnel array 360. The single set of unique corner couplings would prevent the funnel array 360 from being connected to the plate array 300 in an incorrect orientation where the vertices and spouts of the reservoirs 340 on the plate array 300 point away from the outlets 362a-d of the funnels 361a-d, as an attempt to make such a connection would fail as a result of incorrect matching of complementary corners on the plate array 300 and the funnel array 360. In an alternative embodiment, instead of providing a single set of uniquely matched corners, a visual indicator such as matched marking signs on the funnel array 360 and plate array 300 could be provided to instruct a user to connect the funnel array 360 to the plate array 300 in the proper orientation.

As noted above, FIG. 9, shows an arrangement for coupling the funnel array 360 to the plate array 300 for pooling of samples from plates 350a-d. Plate array 300 is similar in construction to plate array 200 with the exception of having reservoirs 340 formed therein, which have a teardrop shaped upper edge 341 and a circular base 343. It is seen in FIG. 9, that the funnel array 360 is placed over the plates 350a-d of the plate array 300.

Collecting vessels 370a-d are connected to the outlets 361a-d of the funnel array 360. This assembly is placed in a separate housing (not shown) designed to rigidly retain the assembly within a centrifuge such that during centrifugation, with the plate array 300 placed upside down, fluids contained within each reservoir 340 are induced to flow out of the reservoir 340 via the spout 348, through the respective funnels 361a-d and outlets 362a-d and into the collecting vessels 370a-d. It is to be understood that all 96 wells of each plate 350a-d will be pooled together into respective collecting vessels 370a-d. Therefore, it is possible to conduct an experiment with four separate conditions or sample components in the four separate plates.

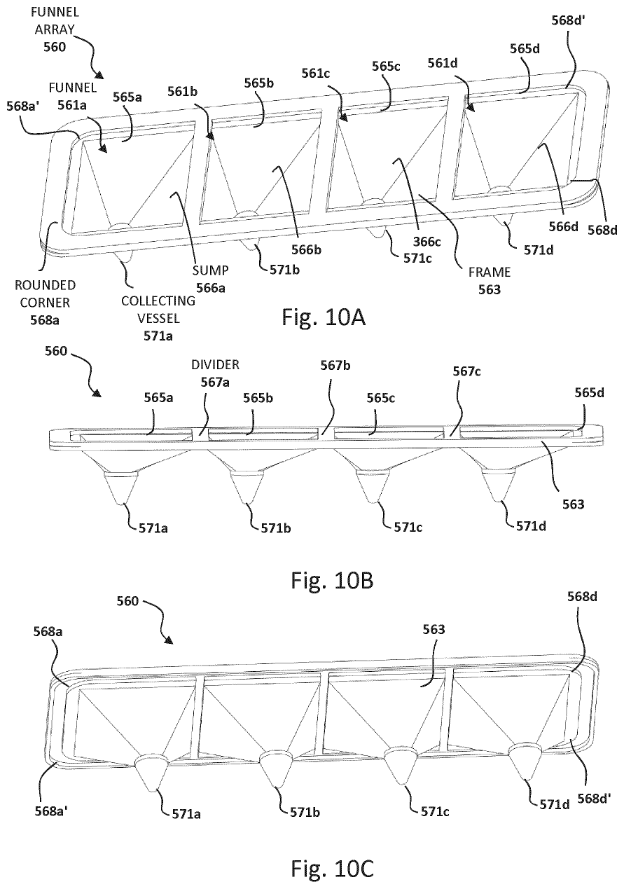

Referring now to FIGS. 10A to 10C, there is shown another funnel array embodiment 560 where similar reference numerals indicate similar features. Like funnel array embodiment 360, funnel array embodiment 560 includes an array frame 563 with inner rounded corners 568a, 568a′, 568d and 568d′, having four funnels 561a-d formed therein. Each of the funnels 561a-d has a vertical sidewall 565a-d and a sump 566a-d. However, instead of an outlet at the bottom of each funnel 561a-d, there is an integrally formed conical collecting vessel 571a-d which can be used for subsequent sample manipulations, rather than requiring a step of transferring samples from the four funnels 561a-d into separate collecting vessels (as shown for funnel array 360 in FIG. 9).

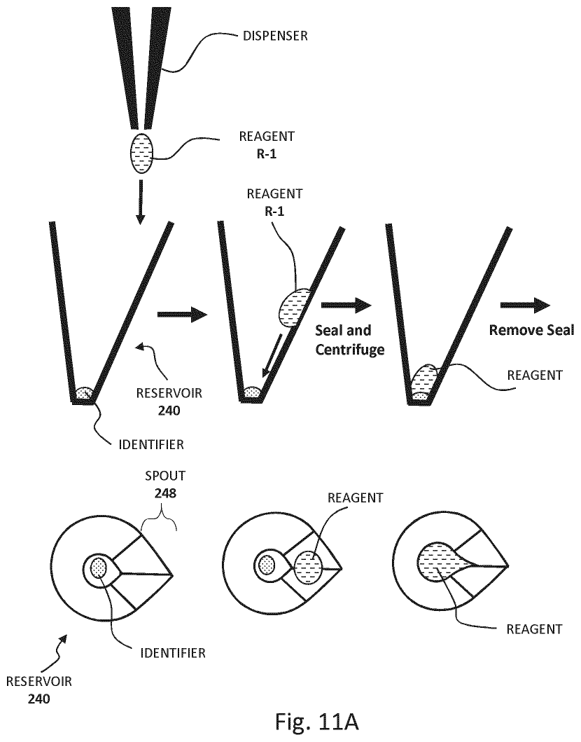

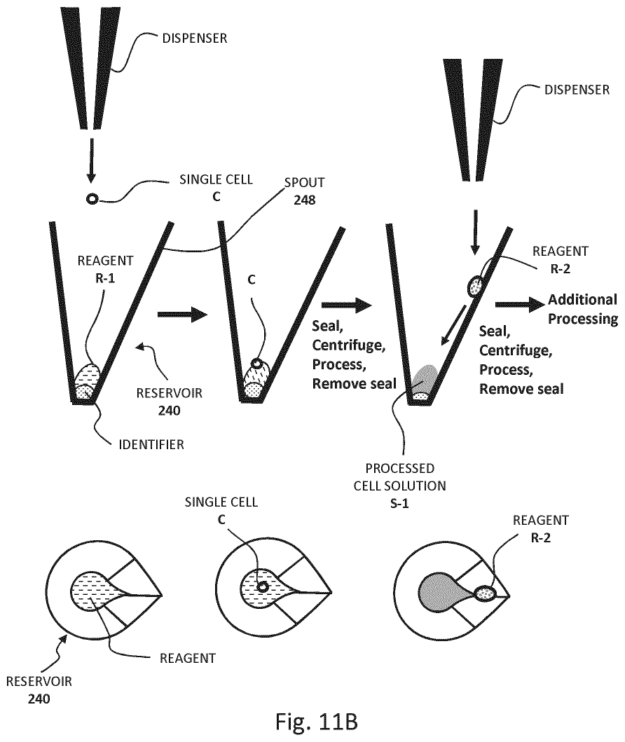

Turning now to FIGS. 11A and 11B, an example of a series of steps of loading reagents and a single cell into a reservoir 240 on plate 200 for a generalized assay. In these diagrams, side cross-sectional views similar to the view shown in FIG. 4B and top views similar to the view shown in FIG. 4A are shown to highlight the advantages of the features of the reservoir 240 which is pre-loaded with a nucleic-acid based molecular identifier. The molecular identifier (sometimes referred to as a “barcode”) is provided for identifying each specific reservoir 240 of the array plate 200. The molecular identifier will have a sequence segment that is unique to for a specific reservoir 240. In some embodiments, the molecular identifier further includes a random set of nucleobases which is known as a unique molecular index for counting copies of genes or transcripts that have been captured. In some embodiments, the molecular identifier also includes a sequence used to capture a known part of the target of interest. In some embodiments, the molecular identifier is a nucleic acid segment of a length of about 16 to about 30 nucleobases. In other embodiments, in applications such as proteomics analyses, the molecular identifier is a heavy metal isotope which is identified by mass spectrometry. In other embodiments the molecular identifier is formed of another identifiable material for mapping data from downstream analysis back to the cell/particle/material dispensed into the reservoir.

A reagent R-1 is dispensed from a dispenser into the reservoir 240 containing the molecular identifier and lands onto the spout side of the reservoir 240 where the reagent is held by capillary force adhesion. In the next step (which would occur after dispensing the reagent into additional reservoirs 240), the array plate 200 is placed in a centrifuge housing (not shown) and centrifuged to move the reagent to the base of the reservoir 240. In the next step (FIG. 11B) a single cell C is dispensed directly into the reservoir such that it lands directly on top of the reagent R-1. At this point, the plate array 200 may be centrifuged again, if needed to properly suspend the cell C in the reagent R-1 thereby providing a processed cell solution S-1. In alternative embodiments, physical forces other than centrifugal forces are employed to move the reagents downward. Examples of such forces include, but are not limited to vibrations, electrostatic forces. In one example, dielectrophoresis is employed to induce movement of the reagents. In some cases, after the cell is dispensed, a centrifugation/mixing step is not required. In the next step, a second reagent R-2 is dispensed onto the spout portion of the reservoir 240 in a manner similar to the dispensation of reagent R-1. This step is followed by centrifugation again to properly mix reagent R-2 into the processed cell solution S-1 in subsequent processing steps which may include dispensing of additional reagents into the reservoir 240 for the assay. It is to be understood that the pitcher shaped reservoir 240 provides a wider opening to allow solution components, biomolecules, cells and other particles to be dispensed at different locations in the reservoir, at least on the spout or directly towards the base of the reservoir 240. In a typical parallel loading protocol, reagents are added in parallel to all reservoirs 240 in a single plate of the plate array 200, wherein all vessels are loaded with the same reagents at the same time. While not shown in FIGS. 11A and 11B, it is to be understood that if dispensers are provided at a sufficient scale, it may be possible to provide simultaneous or substantially simultaneous parallel addition of different components to a given reservoir 240. In some situations, a larger volume of dispensed reagent might result in adhesion across the entire reservoir 240 before it can drop to the bottom of the reservoir 240 or smaller volumes may run down the spout to the bottom of the reservoir 240. In any case, the centrifugation step will ensure that the reagent is properly contained within the reservoir 240 and/or mixed with other components as appropriate. The shape of the reservoir 240 thus provides the advantage of efficiency and flexibility in design of a dispensation protocol. For example, reservoirs of conventional nano-scale plates with narrower openings may not be sufficiently wide to permit parallel dispensation of components. Such a dispensation protocol may be easily implemented using the plate array 200.

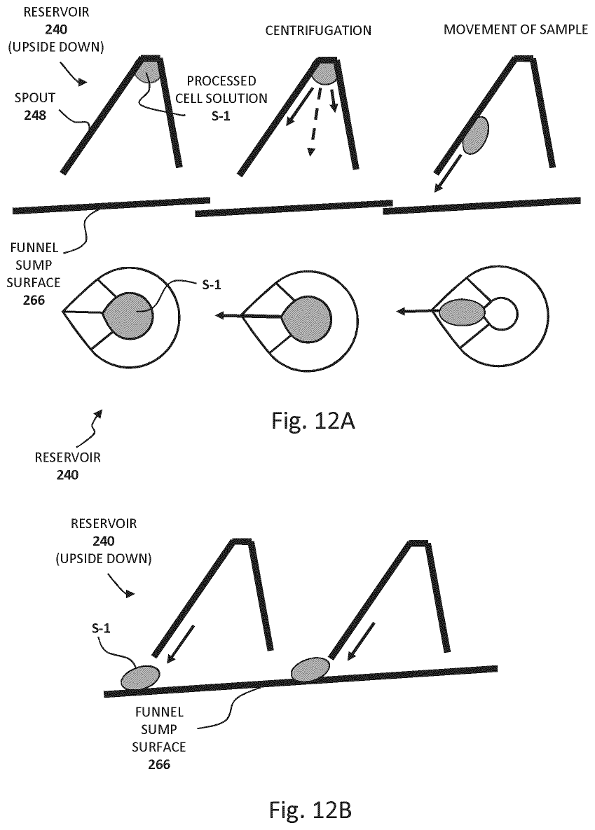

Turning now to FIGS. 12A and 12B, a general process for removal of a processed solution with pooling of samples contained within reservoirs 240 of a single plate is shown using side cross-sectional and top views similar to those used in FIGS. 11A and 11B. As noted above, with respect to the plate array embodiment 300 (FIG. 9) recovery of samples from the plates of a plate array assembly includes arranging the plate array upside down in a centrifuge housing. Thus in FIG. 12A, the reservoir 240 is shown in an inverted orientation facing towards the sloped interior funnel surface, where at first, the processed solution S-1 remains adhered to the base of the reservoir 240. Next, the plate array 200 is placed in a centrifuge housing (not shown) and subjected to appropriate centrifugation to induce the processed solution S-1 to move out of the reservoir 240 and into the connected funnel where it encounters the surface of the funnel sump 266. As noted above, other forces such as controllable vibrations or controllable electrostatic forces may be used as alternatives to centrifugation. In this step, centrifugal forces (indicated by the dashed arrow) and capillary forces (indicated by the solid arrows) act on the processed solution S-1 to draw it from the bottom of the reservoir 240, toward the vertex of the spout 248 as shown. In FIG. 12B, two adjacent reservoirs 240 are shown with processed solutions S-1 having exited the reservoirs 240 with movement along the interior surface of the funnel sump 266. While not shown specifically in FIG. 12B, it is to be understood that the processed samples S-1 merge and are pooled with recovery being made via the funnel outlet leading to a collecting vessel as shown in FIG. 9. As noted above, in alternative embodiments, forces other than the forces provided by a centrifuge are used to induce movement of the samples out of the reservoirs 240. Such forces may include, but are not limited to, vibrations, electrostatic forces and rapid heating to form bubbles causing movement of a droplet in a manner similar to inkjet printers.

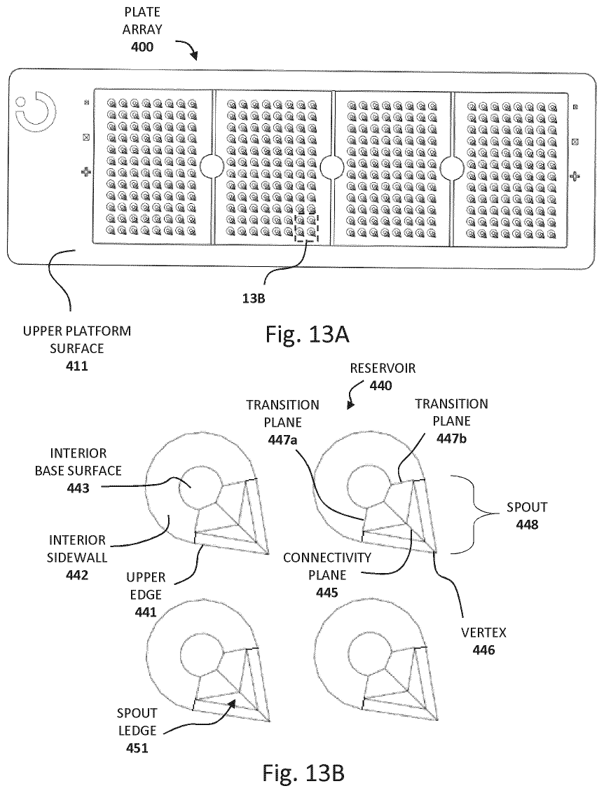

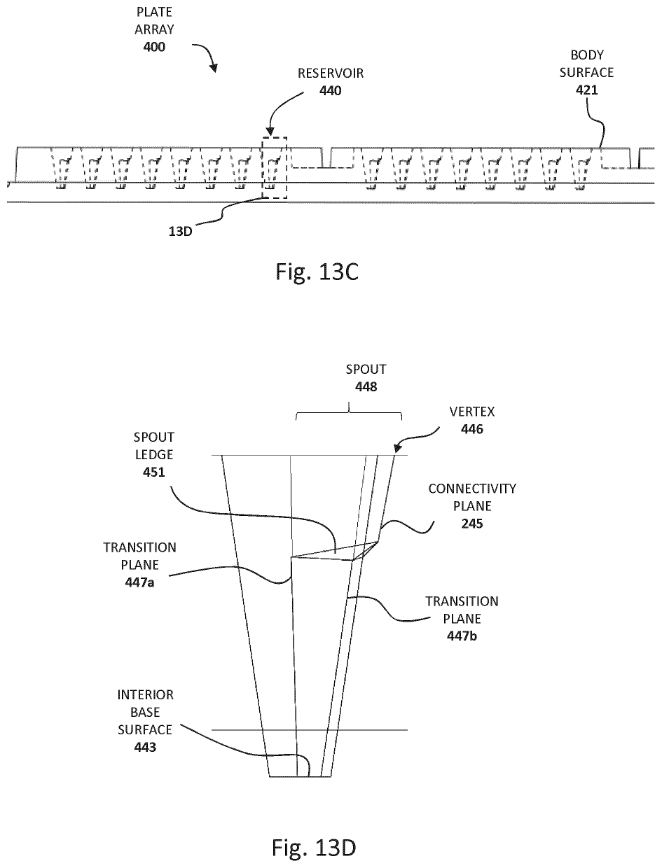

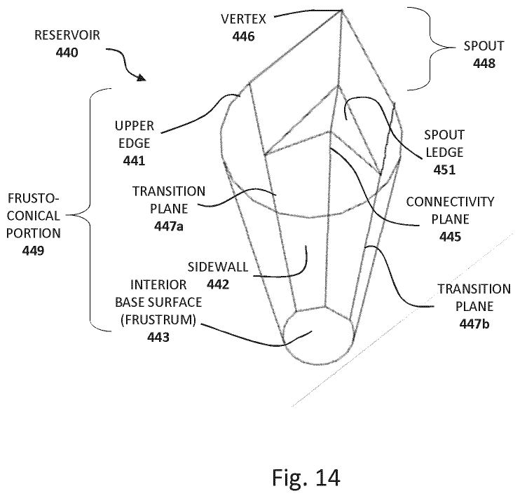

Referring now to FIG. 13A, there is shown another plate array embodiment 400 with a number of similar features shown in plate array embodiments 200 and 300. The plate array 400 has an upper platform surface 411 supporting a body having four plates formed therein with each plate having 96 reservoirs 440 with features shown in different views in FIGS. 13B to 1D and FIG. 14. The top view of four adjacent reservoirs 440 shown in FIG. 13B indicate that each reservoir has an interior base surface 443, an interior sidewall 442, an upper edge 441, a pair of opposed transition planes 447a,b and a connectivity plane 445 which together form a spout 448 with vertex 446 with dimensions distinct from the remaining frustoconical portion 449 of the reservoir 440. These features are similar to the analogous features of reservoir 240 of plate array 200 and reservoir 360 of plate array 300 (FIG. 2D). One difference is that reservoir 460 has a ledge 451 formed in the spout 448 which in this embodiment has a slope which is shallower than the slope of the remaining portions of the spout 448. Additional views of reservoir 440 are shown in FIGS. 13C to 13D and 14.

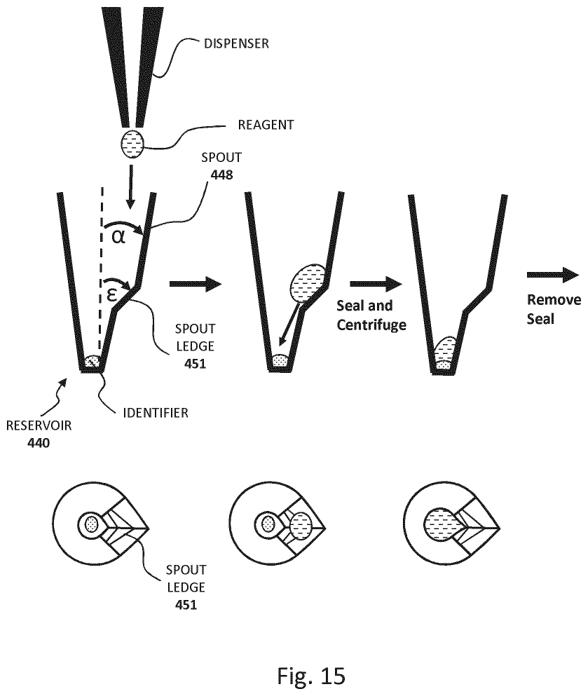

FIG. 15 shows reservoir embodiment 440 in side cross-sectional and top views similar to the views of FIGS. 11A, 11B, 12A and 12B. This reservoir embodiment 440 is provided with a spout ledge 451. FIG. 11A shows that spout ledge 451 is a portion of the spout 448 which is provided at a greater angle ε with respect to the angle α as described for FIG. 4B. FIGS. 15 to 17 indicate that the spout ledge 451 provides for a greater extent of retention of a reagent on the spout 448. This may be advantageous in certain situations where parallel dispensation of two reagents is performed simultaneously or substantially simultaneously, where it is desirable to have one reagent move to the bottom of the reservoir first with the other reagent remaining on the spout ledge 451 until the centrifugation step. FIG. 15 shows a step of dispensing a reagent into the reservoir 440 resulting in the reagent first resting on the ledge 451 before it is induced to move to the bottom of the reservoir by centrifugation for subsequent processing.

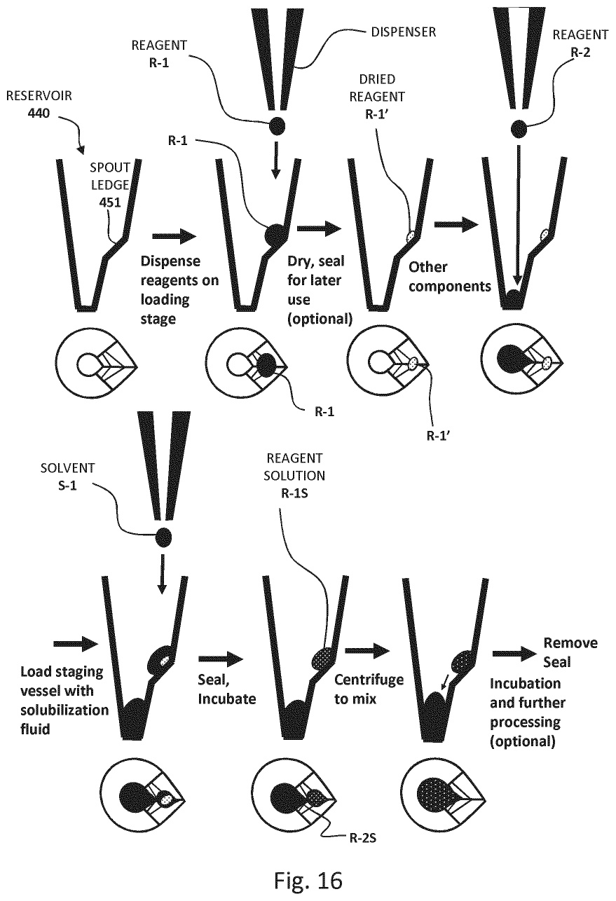

FIG. 16 illustrates how the reservoir 440 can be used to manipulate a reagent R-1 placed on the spout ledge 451 by a dispenser. In situations where reagent R-1 is unstable in solution form or for any other reason, the reagent R-1 resting on the ledge 451 can be dried in place (generating dried reagent R-1′) and the reservoir 440 can be sealed and stored for later use. When the user is ready to conduct an assay, a second reagent R-2 can be dispensed to the bottom of the reservoir 440 and the dried reagent R-1′ can be reconstituted with a solvent S to form a reconstituted reagent solution R-1S. In the next step, the reconstituted reagent solution R-1S is induced to move to the bottom of the reservoir by centrifugation for mixing with reagent R-2.

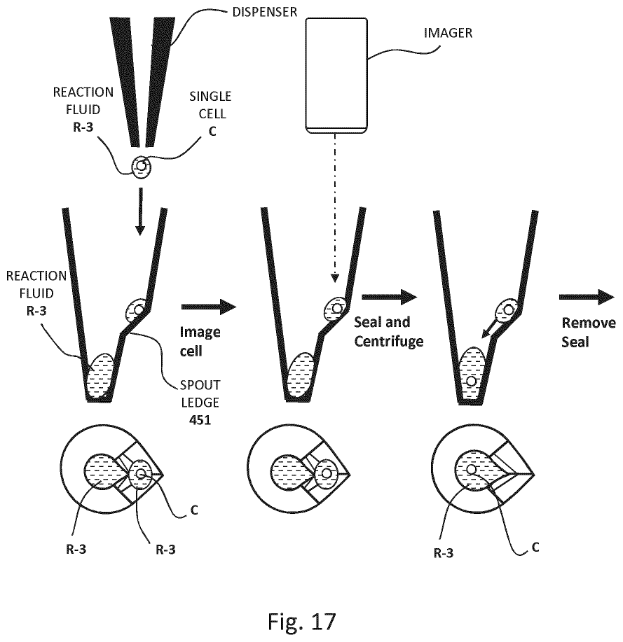

FIG. 17 illustrates how a single cell C suspended in reaction fluid R-3 can be dispensed onto the ledge 451 and imaged thereon prior to inducing the suspended cell C to move to the bottom of the reservoir by centrifugation for subsequent processing.

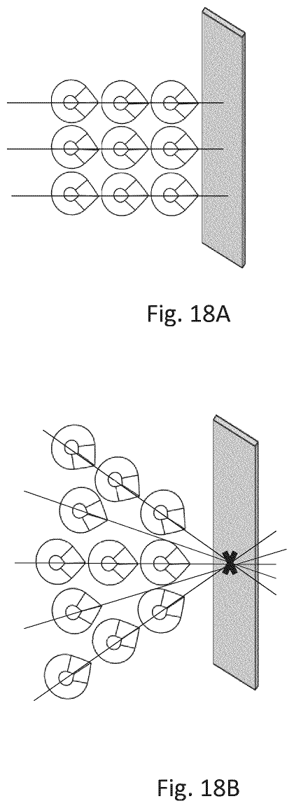

Turning now to FIGS. 18A and 18B, there are shown two possible arrangements for orientation of individual reservoirs on a plate. The reservoirs are shown with top views to indicate the orientation of the vertices of the reservoirs. FIG. 18A has all reservoirs with vertices co-aligned in an orientation perpendicular to the plane shown. This represents the arrangement used in array plate embodiments 100, 200 and 300 described hereinabove. FIG. 18B illustrates a different arrangement wherein all reservoir vertices are directed towards a single point shown centrally on the plane. It is seen in this arrangement that the reservoirs require additional spacing between each other to account for the different orientations of the vertices.

### IV. Plate Arrays in Nano-Scale Assays

The massive parallelization of biological assays and realization of single-molecule resolution have yielded profound advances in the ways that biological systems are characterized and monitored and the way in which biological disorders are treated. Assays are used to interrogate thousands of individual molecules simultaneously, often in real time. These biochemical and medical assays often rely on the accurate and precise positioning of individual assay components on a molecular scale. Thousands of nanoscale assays are often patterned on a substrate for macro-manipulation, analysis, and data recording.

The combination of solid-state electronics technologies to biological research applications has provided a number of important advances including DNA arrays (see, e.g., U.S. Pat. No. 6,261,776, incorporated herein by reference in its entirety), microfluidic chip technologies (see e.g., U.S. Pat. No. 5,976,336, incorporated herein by reference in its entirety), chemically sensitive field effect transistors (ChemFETs), and other valuable sensor technologies.

Next generation sequencing methods are often conducted as nano-scale assays and involve complex reaction mixtures. Examples of such next generation sequencing methods include, but are not limited to, single-molecule real-time sequencing (Pacific Biosciences), ion semiconductor sequencing (ion torrent sequencing), pyrosequencing, sequencing by synthesis (Illumina), Combinatorial probe anchor synthesis (cPAS-BGI/MGI), sequencing by ligation (SOLiD sequencing), nanopore sequencing, and chain termination (Sanger sequencing).

Proteomics assays are also conducted as nano-scale assays and may include analyses and equipment such as antibody-based detection, mass spectrometry, protein chips, and reverse-phased protein microarrays. Proteomics assays are used in applications such as drug discovery, establishment of protein interactions and networks, protein expression profiling, identification of biomarkers, proteogenomics and structural proteomics.

Any or all of the applications described above may benefit from the use of plate arrays such as the plate arrays described herein.

### V. Kits

Certain aspects of the invention include provision of kits for conducting nano-scale assays. Various embodiments of such kits include a plate array including a plurality of plates supported on a platform, such as the plate arrays 100, 200, 300 or 400 described herein or other plates having reservoirs with at least some of the reservoir features described herein. In some embodiments, the plate array includes a molecular identifier contained within each reservoir of each plate of the plate array. In some embodiments, the kit also includes a recovery funnel array with a funnel for each plate. In some embodiments, the funnels are provided as a connected array with a matched funnel for each plate of the plate array to facilitate a process for generating a pooled sample from individual samples contained within individual reservoirs on a plate of the plate array. In some embodiments, the kit includes collection vessels configured to be coupled to the funnel outlets for collection and retention of a pooled sample. In some embodiments, there is provided a kit with a plate array, a funnel array with a series of connected funnels matched to each plate of the plate array, collection vessels and a series of reagents for performing an assay. Some kit embodiments further include a plate array housing configured for connection to a centrifuge to promote sample collection. Other kit embodiments further include a plate array holder configured to be connected to a specific dispensing device. Example embodiments of kits include, but are not limited to kits for performing single cell RNA sequencing, single cell whole genome amplification, and single cell proteomics by mass spectrometry.

### VI. Definitions

Unless stated otherwise, the following terms and phrases have the meanings described below. The definitions are not meant to be limiting in nature and serve to provide a clearer understanding of certain aspects of the present disclosure.

About: As used herein, the term “about” means+/−10% of the recited value.

Approximately: As used herein, the term “approximately” or “about,” as applied to one or more values of interest, refers to a value that is similar to a stated reference value. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Feature: As used herein, a “feature” refers to a characteristic, a property, or a distinctive element.

Sample: As used herein, the term “sample” or “biological sample” refers to a subset of its tissues, cells or component parts (e.g. body fluids, including but not limited to blood, mucus, lymphatic fluid, synovial fluid, cerebrospinal fluid, saliva, amniotic fluid, amniotic cord blood, urine, vaginal fluid and semen). A sample further may include a homogenate, lysate or extract prepared from a whole organism or a subset of its tissues, cells or component parts, or a fraction or portion thereof, including but not limited to, for example, plasma, serum, spinal fluid, lymph fluid, the external sections of the skin, respiratory, intestinal, and genitourinary tracts, tears, saliva, milk, blood cells, tumors, organs. A sample further refers to a medium, such as a nutrient broth or gel, which may contain cellular components, such as proteins or nucleic acid molecule.

Substantially: As used herein, the term “substantially” refers to the qualitative condition of exhibiting total or near-total extent or degree of a characteristic or property of interest. One of ordinary skill in the biological arts will understand that biological and chemical phenomena rarely, if ever, go to completion and/or proceed to completeness or achieve or avoid an absolute result. The term “substantially” is therefore used herein to capture the potential lack of completeness inherent in many biological and chemical phenomena.

Substantially equal: As used herein as it relates to time differences between doses, the term means plus/minus 2%.

Substantially simultaneously: As used herein means within about 0.5 to about 2 seconds.

Tapered: As used herein, means becoming diminished in thickness or width toward one end.

Ledge: As used herein, means a surface being closer to horizontal than adjacent surfaces.

Frustoconical: As used herein, means a truncated conical shape.

Frustrum: As used herein, means a circular shape formed by the plane cutting off the vertex to generate a frustoconical shape.

Array: As used herein, means an ordered series or arrangement.

Reservoir: As used herein, means a cavity designed for retention of fluids.

Assay: As used herein, means an experimental test.

Spout: As used herein, means an extension or lip configured to induce flow of fluids out of a reservoir.

Plane: As used herein, means a flat surface. Any two points on a plane would be connected by a straight line.

Plane of connectivity: As used herein means a plane where two geometric shapes connect to each other.

Transition plane: As used herein, means a plane passing through a surface where the surface transitions from one shape to another shape.

Vertex: As used herein, means the angular point of a geometric shape.

### VII. Equivalents and Scope

Those skilled in the art will recognize or be able to ascertain using no more than routine experimentation, many equivalents to the specific embodiments in accordance with the disclosure herein. The scope of the present disclosure is not intended to be limited to the above Description, but rather is as set forth in the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or the entire group members are present in, employed in, or otherwise relevant to a given product or process.

It is also noted that the term “comprising” is intended to be open and permits but does not require the inclusion of additional elements or steps. When the term “comprising” is used herein, the term “consisting of” is thus also encompassed and disclosed.

Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise.

In addition, it is to be understood that any particular embodiment of the present disclosure that falls within the prior art may be explicitly excluded from any one or more of the claims. Since such embodiments are deemed to be known to one of ordinary skill in the art, they may be excluded even if the exclusion is not set forth explicitly herein. Any particular embodiment of the compositions of the disclosure (e.g., any antibiotic, therapeutic or active ingredient; any method of production; any method of use; etc.) can be excluded from any one or more claims, for any reason, whether or not related to the existence of prior art.

It is to be understood that the words which have been used are words of description rather than limitation, and that changes may be made within the purview of the appended claims without departing from the true scope and spirit of the disclosure in its broader aspects.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All publications, patent applications, patents, and other references mentioned herein are incorporated by reference in their entirety. In case of conflict, the present specification, including definitions, will control. In addition, section headings, the materials, methods, and examples are illustrative only and not intended to be limiting.

1. An assay plate comprising: a body having a plurality of reservoirs formed therein, the reservoirs shaped and aligned in the body in an orientation to induce drainage of fluids contained therein in a desired direction.

2. The assay plate of claim 1, wherein the desired direction is towards a single plane or a single point.

3. The assay plate of claim 2, wherein the reservoirs each have a spout portion, the spout portion having a vertex directed toward the single plane or the single point.

4. The assay plate of claim 3, wherein the reservoirs have a downwardly tapered frustoconical portion adjacent to the spout portion, the frustoconical portion having a frustrum forming a base of the reservoirs.

5. The assay plate of claim 4, wherein the reservoirs comprise a boundary between the frustoconical portion and the spout portion defined by a pair of opposed transition planes each intersecting an inner sidewall of the reservoirs at distances equidistant from the vertex such that a connectivity plane located between the vertex and the center of the base divides the spout into symmetric halves.

6. The assay plate of claim 5, wherein a first angle between a first perpendicular reference plane intersecting an edge of the base closest to the vertex and the connectivity plane is greater than a second angle between a second perpendicular reference plane intersecting the edge of the base in the frustoconical portion and an interior sidewall of the frustoconical portion.

7. The assay plate of claim 4, wherein the reservoir has a teardrop-shaped upper edge and the base is circular or teardrop shaped.

8. The assay plate of claim 6, wherein the spout includes a ledge portion, wherein a third angle between the first perpendicular reference plane and the connectivity plane on the ledge portion is greater than the first angle.

9. The assay plate of claim 1, wherein the body is rectangular and slopes downward from a single elevated corner, wherein the desired direction of the drainage of fluids is towards a corner opposite the elevated corner.

10. The assay plate of claim 1, wherein the body is rectangular with a level upper surface.

11. The assay plate of claim 1, wherein the plurality of reservoirs is 96 reservoirs.

12. The assay plate of claim 1, wherein the reservoirs have volumes of less than about 200 nanoliters.

13. A plate array comprising a plurality of assay plates according to claim 1.

14. The plate array of claim 13 wherein the plurality of assay plates is four plates.

15. An assembly comprising a rectangular plate array according to claim 13 and a rectangular funnel array comprising a plurality of rectangular funnels, each configured for connection to a single plate of the plurality of plates.

16. The assembly of claim 15, wherein each of the rectangular funnels has a collecting vessel located closer to one corner of the rectangular funnels and wherein, when the funnel array is connected to the plate array, the desired direction of drainage of fluids from each plate of the plurality of rectangular plates is towards the collecting vessel of a connected funnel of the plurality of rectangular funnels.

17. The assembly of claim 16, wherein the corners of the plate array are shaped to accept the corners of the funnel array in only a single orientation, thereby ensuring that the desired direction of drainage of fluids is towards the collecting vessel.

18. The assembly of claim 15, wherein a transverse channel is provided between adjacent plates of the plate array.

19. The assembly of claim 15, further comprising a housing for coupling the assembly to a rotor of a centrifuge.

20. A kit for conducting an assay, the kit comprising: a plate array as recited in claim 13, a rectangular funnel array comprising a plurality of rectangular funnels, each configured for connection to a single plate of the plurality of plates, and instructions for connecting the funnel array to the plate array for draining fluids from the reservoirs of the plate array via centrifugation.

21. The kit of claim 20, further comprising a housing for retaining the plate array and funnel array in a connected arrangement in a centrifuge.

22. The kit of claim 20, wherein the collecting vessels are attached to or formed integrally with the funnels of the funnel array.

23. The kit of claim 20, further comprising a frame configured to hold the plate array during dispensing of components into the reservoirs during preparation of the assay.

24. The kit of claim 20, wherein each one of the reservoirs includes an identifier for identifying each one of the reservoirs during the assay.

25. The kit of claim 24, wherein the identifier is a nucleic acid molecule or a heavy metal with an isotope identifiable by mass spectrometry.

26. The kit of claim 20, further comprising reagents for the assay provided in individual vessels.

27. The kit of claim 20, wherein the assay is a sequencing assay, a gene expression assay or a protein expression assay.
